(19) United States
(12) Patent Application Publication
(10) Pub. No.: US 2024/0083437 A1
(43) Pub. Date: Mar. 14, 2024

(54) METHOD AND DEVICE FOR ACTIVATING AN OVERTAKING ASSISTANCE FUNCTION OF A SINGLE-TRACK MOTOR VEHICLE

(71) Applicant: Robert Bosch GmbH, Stuttgart (DE)

(72) Inventor: Daniel Vetter, Farmington Hills, MI (US)

(21) Appl. No.: 18/262,804

(22) PCT Filed: Mar. 2, 2022
(86) PCT No.: PCT/EP2022/055287

§ 371 Date: Jul. 25, 2023

(30) Foreign Application Priority Data
May 18, 2021 (DE) 10 2021 204 998.2

(51) Int. Cl. B60W 30/18

(52) U.S. Cl. CPC B60W 30/18163; B60W 2300/36; B60W 2540/20; B60W 2552/10; B60W 2554/802; B60W 2720/106

(57) ABSTRACT

A method and a device for activating an overtaking assistance function of a single-track motor vehicle by way of a rider-actuatable operating element of a turning signal indicator, the single-track motor vehicle additionally having a distance and/or speed control function, in which the duration of actuation of the operating element is determined, and, in the event that the duration of actuation exceeds a specified threshold value, interventions by the distance and/or speed control function are temporarily suppressed during the rider-independent acceleration phase of the overtaking assistance function.

### BACKGROUND INFORMATION

German Patent Application No. DE 10 2019 208 484 A1 describes a method for rider-independent adjustment of the longitudinal acceleration of a single-track motor vehicle, in which, by way of an environment sensor system, the vehicle ahead of the single-track vehicle is detected and defined as a target object, driving dynamics data are determined by means of the same or another environment sensor system, the longitudinal acceleration of the single-track motor vehicle is set as a function of the driving dynamics data, it is determined whether the target object is still being detected by way of the environment sensor system and, in the event that the target object is no longer being detected, the speed of the single-track motor vehicle is set to a specified value, the speed being adjusted to the specified value in such a way that a specified acceleration limit value is not exceeded.

### SUMMARY

The present invention relates to a method for activating an overtaking assistance function of a single-track motor vehicle by way of a rider-actuatable operating element of a turning signal indicator, the single-track motor vehicle additionally having a distance and/or speed control function, in which
the duration of actuation of the operating element is determined and,
in the event that the duration of actuation exceeds a specified threshold value, interventions by the distance and/or speed control function are temporarily suppressed during the rider-independent acceleration phase of the overtaking assistance function.

One advantageous embodiment of the present invention is characterized in that the operating element is a turning signal lever.

One advantageous embodiment of the present invention is characterized in that, once activated by the rider, the overtaking assistance function performs a rider-independent acceleration of the motor vehicle for a time interval of a specified length.

One advantageous embodiment of the present invention is characterized
in that the distance and/or speed control function is based on an environment sensor system,
in that the environment sensor system determines whether the motor vehicle is located on a single-lane or multi-lane roadway and,
if a single-lane roadway is present, the overtaking assistance function is not activatable.

One advantageous embodiment of the present invention is characterized in that the time interval of a specified length has a value of between 1 second and 2 seconds.

One advantageous embodiment of the present invention is characterized in that the single-track motor vehicle is a motorcycle.

The present invention further comprises a device containing means which are configured to carry out the method according to the present invention. The device is in particular a control device in which the program code for carrying out the method according to the present invention is stored.

### BRIEF DESCRIPTION OF THE DRAWINGS

FIG. 1 shows the basic sequence of one example embodiment of the method according to the present invention.

### DETAILED DESCRIPTION OF EXAMPLE EMBODIMENTS

An overtaking assistance function is primarily intended for use on multi-lane roads. To this end, this function carries out rider-independent acceleration of the motor vehicle, so as to enable an overtaking maneuver which is convenient for the rider. As a result, the rider can concentrate better on monitoring the current traffic situation during the overtaking maneuver.

The overtaking assistance function is frequently a component or sub-function of a distance and/or speed control function. By way of a suitable environment sensor system, for example a radar or video sensor system, a distance and/or speed control function captures the region located in front of the vehicle and ensures that the ego-vehicle is not approaching too close or too quickly a vehicle ahead detected by way of the environment sensor system.

If the rider on a multi-lane roadway initiates an overtaking maneuver of a vehicle ahead in the same lane and activates an overtaking assistance function, a situation may then arise in which the requested acceleration conflicts with the distance and/or approach speed requirements of the distance and/or speed control function. This latter function will then suppress the rider-independent acceleration until the vehicle ahead is far enough away from the ego-vehicle.

In this case, on initiating the overtaking maneuver, the driver would then move to the adjacent lane without assistance from the requested acceleration, and the requested rider-independent acceleration would not occur until the new lane was reached. This behavior would feel very unnatural to the rider.

Such a situation can be prevented if interventions by the distance and/or speed control function are suppressed during the acceleration phase of the overtaking assistance function.

In addition to complete suppression of the interventions by the distance and/or speed control function, it is also possible to permit interventions thereby only if there is an imminent danger of collision with the vehicle ahead.

The safety of the overtaking assistance function can be further increased if, for example, the environment sensor system is used to determine whether the vehicle is on a single-lane or multi-lane road or roadway. It is also possible to prevent activation of the overtaking assistance function in the case of a single-lane roadway.

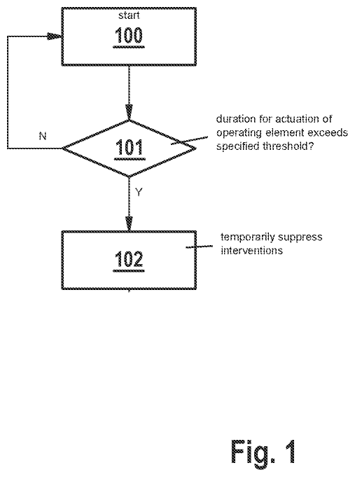

FIG. 1 shows the basic sequence of one embodiment of the method according to the present invention. After the start in step 100, it is determined in step 101 whether the duration of actuation of an operating element for activating an overtaking assistance function exceeds a specified threshold value. If this is not the case, then the system returns to step 100. If the threshold value is exceeded, then in step 102 interventions by a distance and/or speed control function are subsequently temporarily suppressed in block 102 during the rider-independent acceleration phase of the overtaking assistance function.

1-7. (canceled)

8. A method for activating an overtaking assistance function of a single-track motor vehicle using a rider-actuatable operating element of a turning signal indicator, the single-track motor vehicle additionally having a distance and/or speed control function, the method comprising the following steps:
determining a duration of actuation of the operating element; and
when the duration of actuation exceeds a specified threshold value, temporarily suppressing interventions by the distance and/or speed control function during a rider-independent acceleration phase of the overtaking assistance function.

9. The method as recited in claim 8, wherein the operating element is a turning signal lever.

10. The method as recited in claim 8, wherein, once activated by the rider, the overtaking assistance function performs a rider-independent acceleration of the motor vehicle for a time interval of a specified length.

11. The method as recited in claim 8, wherein:
the distance and/or speed control function is based on an environment sensor system,
the environment sensor system determines whether the single-track motor vehicle is located on a single-lane or multi-lane roadway,
when the single-lane roadway is present, the overtaking assistance function is not activatable.

12. The method as recited in claim 10, wherein the time interval of a specified length has a value of between 1 second and 2 seconds.

13. The method as recited in claim 8, wherein the single-track motor vehicle is a motorcycle.

14. A device configured to activate an overtaking assistance function of a single-track motor vehicle using a rider-actuatable operating element of a turning signal indicator, the single-track motor vehicle additionally having a distance and/or speed control function, the device configured to:
determine a duration of actuation of the operating element; and
when the duration of actuation exceeds a specified threshold value, temporarily suppress interventions by the distance and/or speed control function during a rider-independent acceleration phase of the overtaking assistance function.
